(19) United States
(12) Patent Application Publication
(10) Pub. No.: US 2008/0081218 A1
(43) Pub. Date: Apr. 3, 2008

(54) Magnetic recording medium, recording apparatus, and method and apparatus for manufacturing magnetic recording medium

(75) Inventors: Kazuhisa Shida, Higashine (JP); Yuki Yoshida, Higashine (JP); Jun Taguchi, Higashine (JP); Noriyuki Asakura, Higashine (JP); Akira Kikuchi, Higashine (JP)

Correspondence Address: Patrick G. Burns, Esq.;GREER, BURNS & CRAIN, LTD., Suite 2500, 300 South Wacker Dr., Chicago, IL, 60606, US

(73) Assignee: Fujitsu Limited, Kawasaki-shi (JP)

(21) Appl. No.: 11/789,297

(22) Filed: Apr. 24, 2007

(30) Foreign Application Priority Data
Sep. 28, 2006 (JP) 2006-266078

(51) Int. Cl. G11B 5/33

(52) U.S. Cl. 428/810; 977/932

(57) ABSTRACT

A magnetic recording medium includes a substrate, an underlayer of a chromium alloy formed on the substrate, a ferromagnetic layer formed on the underlayer, a spacer layer formed on the ferromagnetic layer, and a recording layer of a cobalt-chromium alloy formed on the spacer layer. The spacer layer is formed with a ruthenium-cobalt-based alloy.

### BACKGROUND OF THE INVENTION

1. Field of the Invention

The present invention generally relates to a technology for enhancing a signal-to-noise ratio (SNR) and realizing high-density magnetic recording characteristics of a magnetic recording medium.

2. Description of the Related Art

With the development of the information processing technology, magnetic disk devices used as external recording units are required to have a larger capacity and a higher transfer rate. To meet the above needs., it is necessary to upgrade a magnetic recording medium by reducing a noise, so that the SNR is increased. To reduce the noise of the magnetic recording medium, it is necessary to reduce a diameter of a magnetic particle in a recording layer and to enhance the c-axis, which is easy to be magnetized, in-plane orientation of magnetization in the recording layer.

The smaller the diameter of the magnetic particle in the recording layer becomes, the more likely signal degradation happens due to an effect from a demagnetizing field and thermal fluctuation. To increase the thermal stability, for example, Japanese Patent Application Laid-Open No. 2001-56924 discloses a technique of producing a magnetic recording medium including a spacer layer formed between a ferromagnetic layer and a recording layer to cause magnetization directions of the ferromagnetic layer and the recording layer nonparallel to each other.

In the magnetic recording medium according to the above technique, when a magnetic field for recording is not applied, because the ferromagnetic layer has residual magnetization, the magnetic direction of the ferromagnetic layer is inverted, so that the magnetic directions of the ferromagnetic layer and the recording layer are nonparallel to each other. By inverting the magnetic direction of the ferromagnetic layer, an apparent thickness of the entire recording layer can increase. As a result, the magnetic recording medium can keep written bit-data with a high thermal stability, which enables the magnetic recording medium to correspond to a high recording density.

An exchanged-coupled structure using the above spacer layer is effective to increase the thermal stability. However, because ruthenium (Ru), which is generally used as the spacer layer, has a larger crystal lattice than that of the ferromagnetic layer and the recording layer including cobalt (Co) as a main constituent, the created medium is deteriorated in crystal due to lattice mismatching at interfaces between the ferromagnetic layer and the spacer layer and between the spacer layer and the recording layer.

### SUMMARY OF THE INVENTION

It is an object of the present invention to at least partially solve the problems in the conventional technology.

A magnetic recording medium according to one aspect of the present invention includes a substrate; an underlayer of a chromium alloy formed on the substrate; a ferromagnetic layer formed on the underlayer; a spacer layer formed on the ferromagnetic layer; and a recording layer of a cobalt-chromium alloy formed on the spacer layer. The spacer layer is formed with a ruthenium-cobalt-based alloy.

A recording apparatus according to another aspect of the present invention includes a magnetic recording medium that includes a substrate, an underlayer of a chromium alloy formed on the substrate, a ferromagnetic layer formed on the underlayer, a spacer layer of a ruthenium-cobalt-based alloy formed on the ferromagnetic layer, and a recording layer of a cobalt-chromium alloy formed on the spacer layer; and a magnetic head that performs reading or writing of magnetic data with respect to the magnetic recording medium.

A method of manufacturing a magnetic recording medium according to still another aspect of the present invention includes forming an underlayer by coating a chromium alloy film on a substrate; forming a ferromagnetic layer on the underlayer; forming a spacer layer by coating a ruthenium-cobalt-based alloy film on the ferromagnetic layer; and forming a recording layer by coating a cobalt-chromium alloy film on the spacer layer.

An apparatus according to still another aspect of the present invention is for manufacturing a magnetic recording medium by sequentially forming an underlayer of a chromium alloy, a ferromagnetic layer, a spacer layer, and a recording layer of a cobalt-chromium alloy on a substrate. The spacer layer is made of a ruthenium-cobalt-based alloy.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a magnetic recording medium according to an embodiment of the present invention;

FIG. 2 is a functional block diagram of an apparatus for manufacturing the magnetic recording medium shown in FIG. 1;

FIG. 3 is a graph for explaining a relation between a cobalt (Co) doping amount and a coercive force in a ruthenium-cobalt spacer layer according to the embodiment;

FIG. 4 is a graph for explaining a relation between the Co doping amount and an SNR in the ruthenium-cobalt (RuCo) spacer layer according to the embodiment;

FIG. 5 is a graph for explaining a relation between the Co doping amount and a noise in the RuCo spacer layer according to the embodiment;

FIG. 6 is a graph for explaining a relation between a thickness of the RuCo spacer layer and a signal-to-noise ratio (SNR) according to the embodiment;

FIG. 7 is a table of sizes of crystal lattices in a ferromagnetic layer, spacer layers, and a recording layer according to the embodiment; and

FIG. 8 is a perspective view of a recording apparatus according to the embodiment.

### DETAILED DESCRIPTION OF THE PREFERRED EMBODIMENTS

Exemplary embodiments of the present invention are described in detail below with reference to the accompanying drawings.

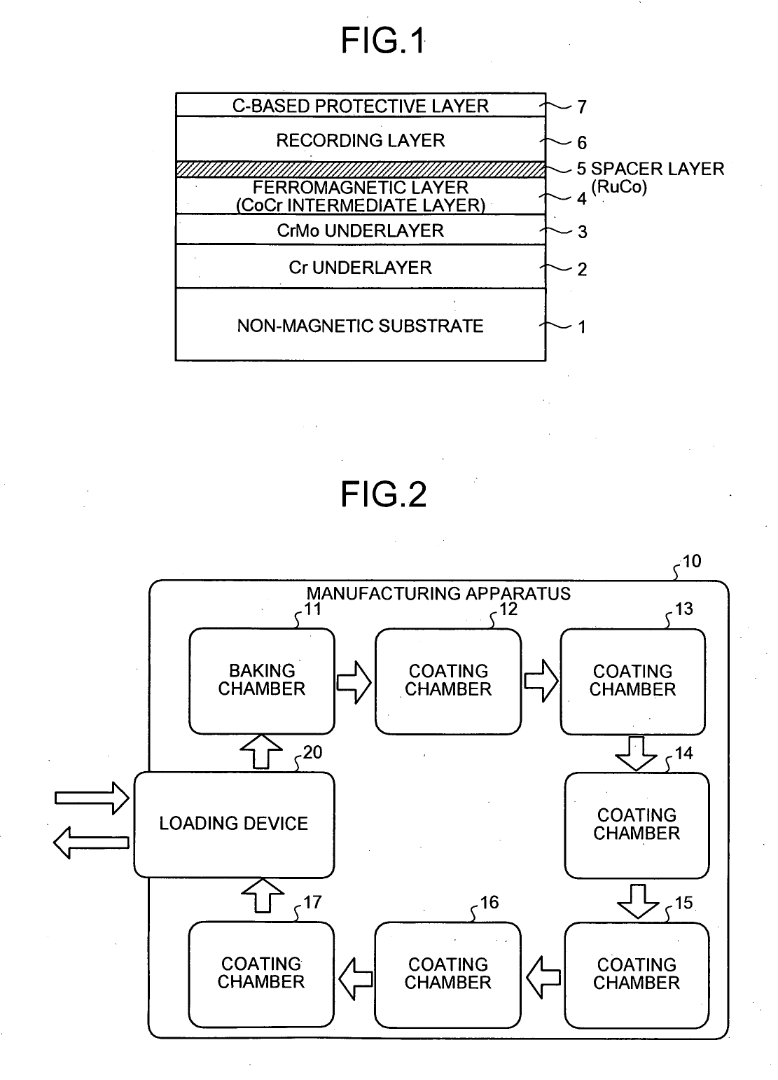

FIG. 1 is a side view of a magnetic recording medium according to an embodiment of the present invention. The magnetic recording medium according to the embodiment includes a non-magnetic substrate 1, an underlayer 2 made of a chromium (Cr) alloy, an underlayer 3 made of chromium-molybdenum (CrMo), a ferromagnetic layer 4 made of a cobalt-chromium-based (CoCr-based) alloy or the like, a spacer layer 5 made of RuCo, a recording layer 6 made of, a CoCr-based alloy or the like, and a carbon-based protective layer 7, sequentially laminated.

By adding cobalt that is a main constituent of the recording layer 6 and that has a small crystal lattice into the spacer layer 5, a difference between sizes of crystal lattices in the recording layer 6 and in the spacer layer 5 can be reduced, so that the spacer layer 5 has such a lattice matching property that is higher than that of the conventional spacer layer made of pure Ru. As a result, the c-axis orientation in the recording layer 6 is improved, so that an obtained SNR becomes higher and the noise is lowered, which enables the magnetic recording medium to be suitable for a higher recording density.

FIG. 2 is a functional block diagram of a manufacturing apparatus 10 for manufacturing the magnetic recording medium shown in FIG. 1. The manufacturing apparatus 10 accommodates a baking chamber 11 and coating chambers 12 to 17 sequentially connected to a loading device 20.

The loading device 20 loads and ejects a substrate on and from the manufacturing apparatus 10. The loading device 20 sends the substrate 1 that is made of aluminum and the surface of which is textured and coated with nickel-phosphorus by electroless plating to the baking chamber 11.

The baking chamber 11 bakes the substrate 1 loaded by the loading device 20. A gas in the baking chamber 11 is exhausted to keep the chamber pressure at 4×10-5 Pa (Pascal) or lower. The substrate 1 in the baking chamber 11 is baked at 220° C. The coating chambers 12 to 17 are used for a continuous direct-current (DC) sputtering. An argon gas is introduced to the coating chambers 12 to 17 to keep inner pressures at 6.7×10-1 Pa.

The underlayer 2 with a thickness of 4 nanometers, the underlayer 3 with a thickness of 2 nanometers, the ferromagnetic layer 4 with a thickness of 2 nanometers, the spacer layer 5, the recording layer 6, and the protective layer 7 are sequentially formed on the substrate 1 by sputtering in the coating chambers 12 to 17, respectively.

After the protective layer 7 is formed in the coating chamber 17, the loading device 20 ejects the substrate from the manufacturing apparatus 10.

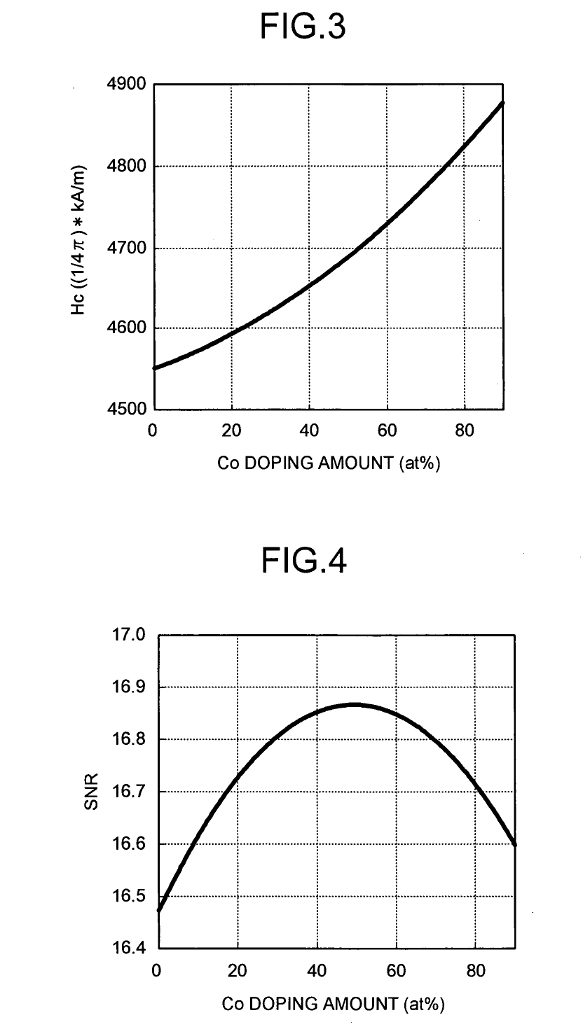

FIG. 3 is a graph of a coercive force (Hc) of the medium, when the Co doping amount in the RuCo spacer layer 5 changes. A vibrating sample magnetometer is used to measure the Hc. The horizontal axis of a graph shown in FIG. 3 represents a doping amount of Co to Ru (at %). At the zero point of the horizontal axis, the medium is made of pure Ru. As the doping amount increases, the HC also increases.

FIG. 4 is a graph of an SNR of the medium with a recording density of 720 kfci (kilo flux changes per inch), when the Co doping amount in the RuCo spacer layer 5 changes. The horizontal axis of a graph shown in FIG. 4 represents at %. At the zero point of the horizontal axis, the medium is made of pure Ru. As at % increases, the SNR increases, and when at % is a range from 40% to 60%, the SNR is maximized.

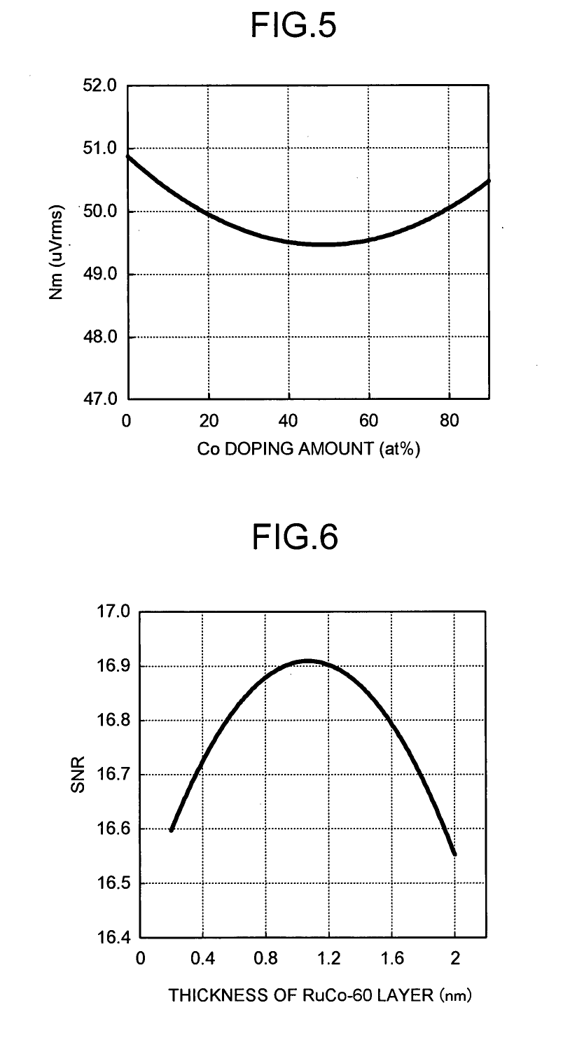

FIG. 5 is a graph of a noise of the medium with a recording density of 720 kfci, when the Co doping amount in the RuCo spacer layer 5 changes. The horizontal axis of a graph shown in FIG. 5 represents at %. At the zero point of the horizontal axis, the medium is made of pure Ru. As at % increases, the noise decrease, and when at % is in a range from 40% to 60%, the noise is minimized.

In this manner, if the Co doping amount is in a range from 40% to 60%, the noise is minimized and the SNR is maximized. On the other hand, the Hc increases as the Co doping amount increases. Based on the results, the spacer layer 5 according to the embodiment is made of RuCo60, in which 60% of Co is doped to Ru.

FIG. 6 is a graph of the SNR of the medium with a recording density of 720 kfci, when a thickness of the RuCo60 spacer layer 5 changes. The horizontal axis of a graph shown in FIG. 6 represents the thickness of the RuCo60 spacer layer 5. When the thickness is 2 nanometers or thinner, more particularly in a range from 0.8 nanometers to 1.2 nanometers, the SNR is maximized, and therefore, a better SNR can be obtained in this range.

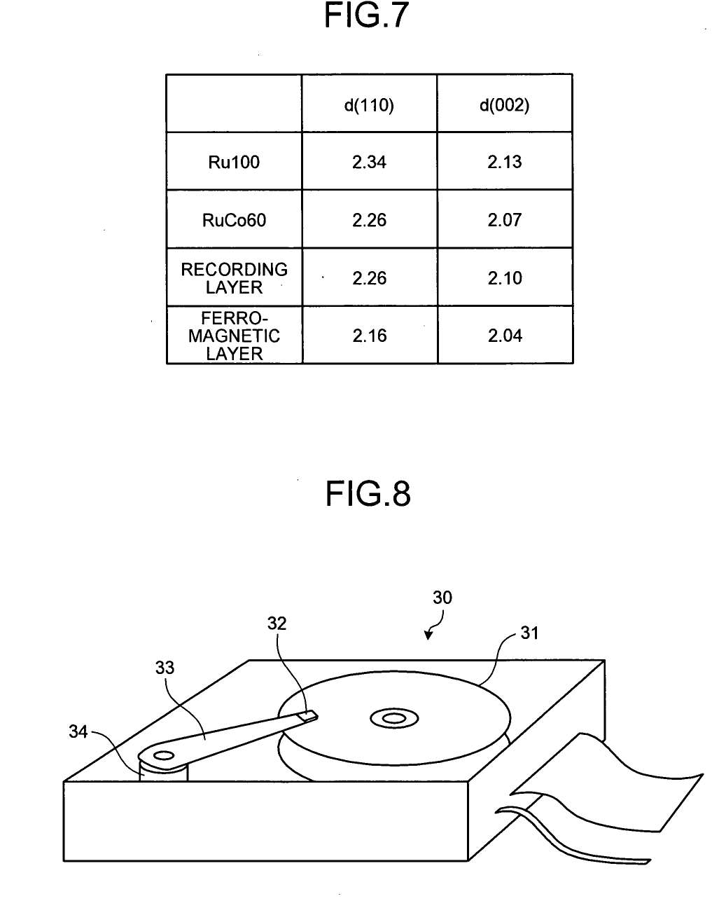

FIG. 7 is a table for comparing sizes of crystal lattices in the spacer layers 5 with those in the recording layer 6 and the ferromagnetic layer 4. Two types of the spacer layers 5, i.e., a Ru100 spacer layer and the RuCo60 spacer layer, are shown in the table. The Ru100 spacer layer is made of pure Ru, while the RuCo60 spacer layer contains 60% of Co. Two types of lattice directions, i.e., d(110) and d(002), are shown for each of the ferromagnetic layer 4, the spacer layers 5, and the recording layer 6. An X-ray diffractometer is used to measure the sizes of the crystal lattices.

As shown in FIG. 7, the size of the crystal lattice of the Ru100 spacer layer is larger than that of the recording layer 6. The size of the crystal lattice of the RuCo60 spacer layer is equal to or smaller than that of the recording layer 6 and equal to or larger than that of the ferromagnetic layer 4.

More particularly, the sizes of the crystal lattices in d(110) are 2.16 Å for the ferromagnetic layer 4, 2.26 Å for the spacer layer 5, and 2.26 Å for the recording layer 6. The sizes of the crystal lattices in d(002) are 2.04 Å for the ferromagnetic layer 4, 2.07 Å for the spacer layer 5, and 2.10 Å for the recording layer 6.

Because the size of the crystal lattice of each layer is larger than those of the lower layers, which are closer to the substrate 1, the difference between the sizes of crystal lattices can be smaller, which enhances the c-axis orientation in the recording layer 6.

By employing the above medium, a recording apparatus 30 shown in FIG. 8 can gain a high capacity and a high transfer rate. The recording apparatus 30 includes a magnetic disk 31, a magnetic head 32, an arm 33, and an actuator 34. The magnetic disk 31 is the magnetic recording medium shown in FIG. 1. The magnetic head 32 reads or writes magnetic data from or to the magnetic disk 31. The arm 33 and the actuator 34 control positioning of the magnetic head 32.

As described above, the magnetic recording medium according to the embodiment can obtain a coercive force, an SNR, a recording-and-reproducing resolution, all of which higher than those of the conventional magnetic recording medium including a spacer layer made of pure Ru, by forming the underlayers and the magnetic layers on the textured non-magnetic substrate in a series of vacuum sputtering processes. By applying the technique used in the magnetic recording medium to a recording apparatus, it is possible to manufacture a magnetic recording apparatus with a recording density higher than that of the conventional recording apparatus.

As a modification of the embodiment, for example, it is allowable to form three or more Cr alloy underlayers containing Cr and any one of elements molybdenum, titanium, tungsten, vanadium, tantalum, manganese, and boron, with a total percentages of the elements other than Cr for each of the underlayers being larger than those in the lower underlayers. It is also allowable to form the Cr underlayer with 10 nanometers or thinner.

It is preferable to form the ferromagnetic layer from an alloy containing Co as a main constituent and at least any one of elements chromium, tantalum, molybdenum, and manganese. The thickness of the ferromagnetic layer is preferably in a range from 1 nanometer to 5 nanometers.

The recording layer 6 made of a CoCr-based alloy preferably includes two or more CoCr-based films, each subsequently laminated. Each of the films preferably has a Cr doping amount larger than those in the upper films, and has a total doping amount of elements larger than Co in radius larger than those in the upper layers.

As described above, according to an aspect of the present invention, because a lattice-matching property between the ferromagnetic layer and the recording layer is improved, the produced magnetic recording medium has an excellent c-axis orientation in the recording layer while having a high SNR with a low noise. Therefore, it is possible to provide the magnetic recording medium corresponding to a high recording density.

Furthermore, according to another aspect of the present invention, because a size of a crystal lattice of each layer is larger than that of the lower layers, which are closer to the substrate, the produced magnetic recording medium has an excellent c-axis orientation while having a high SNR. Therefore, it is possible to provide the magnetic recording medium corresponding to a high recording density.

Moreover, according to still another aspect of the present invention, it is possible to provide the recording apparatus with a large capacity and a high transfer rate.

Furthermore, according to still another aspect of the present invention, it is possible to provide the method of manufacturing the magnetic recording medium with a high SNR by improving the lattice-matching property between the spacer layer and both the ferromagnetic layer and the recording layer.

Furthermore, according to still another aspect of the present invention, it is possible to provide the apparatus for manufacturing the magnetic recording medium with a high SNR by improving the lattice-matching property between the spacer layer and both the ferromagnetic layer and the recording layer.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnetic recording medium comprising:
a substrate;
an underlayer of a chromium alloy formed on the substrate;
a ferromagnetic layer formed on the underlayer;
a spacer layer formed on the ferromagnetic layer; and
a recording layer of a cobalt-chromium alloy formed on the spacer layer, wherein
the spacer layer is formed with a ruthenium-cobalt-based alloy.

2. The magnetic recording medium according to claim 1, wherein the spacer layer contains 40% to 80% of cobalt.

3. The magnetic recording medium according to claim 1, wherein a thickness of the spacer layer is in a range from 0.3 nanometer to 2 nanometers.

4. The magnetic recording medium according to claim 1, wherein a crystal lattice size of the spacer layer is equal to or larger than that of the ferromagnetic layer and equal to or smaller than that of the recording layer.

5. A recording apparatus comprising:
a magnetic recording medium that includes
a substrate,
an underlayer of a chromium alloy formed on the substrate,
a ferromagnetic layer formed on the underlayer,
a spacer layer of a ruthenium-cobalt-based alloy formed on the ferromagnetic layer, and
a recording layer of a cobalt-chromium alloy formed on the spacer layer; and
a magnetic head that performs reading or writing of magnetic data with respect to the magnetic recording medium.

6. A method of manufacturing a magnetic recording medium comprising:
forming an underlayer by coating a chromium alloy film on a substrate;
forming a ferromagnetic layer on the underlayer;
forming a spacer layer by coating a ruthenium-cobalt-based alloy film on the ferromagnetic layer; and
forming a recording layer by coating a cobalt-chromium alloy film on the spacer layer.

7. An apparatus for manufacturing a magnetic recording medium by sequentially forming an underlayer of a chromium alloy, a ferromagnetic layer, a spacer layer, and a recording layer of a cobalt-chromium alloy on a substrate, wherein the spacer layer is made of a ruthenium-cobalt-based alloy.
